(19) United States
(12) Patent Application Publication
(10) Pub. No.: US 2007/0012603 A1
(43) Pub. Date: Jan. 18, 2007

(54) Method and system for managing registered mails

(75) Inventors: Jeong-Hyun Park, Daejeon (KR); Jong-Heung Park, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Electronics & Telecommunications Research Institute

(21) Appl. No.: 11/317,621

(22) Filed: Dec. 22, 2005

(30) Foreign Application Priority Data
Jul. 15, 2005 (KR) 10-2005-0064297

(51) Int. Cl. B07C 5/00

(52) U.S. Cl. 209/584

(57) ABSTRACT

A registered mail management system and a method thereof are provided. The registered mail management system and the method automatically sorts out and distributes registered mails based on destination zip codes. Therefore, the enormous costs for the manual registered mail management are reduced and the inefficiency in the registered mail management is improved.

### RELATED APPLICATION

The present application is based on, and claims priority from, Korean Application Number 2005-0064297, filed Jul. 15, 2005, the disclosure of which is hereby incorporated by reference herein in its entirety.

### BACKGROUND OF THE INVENTION

1. Field of the Invention

The present invention relates to a method and system for managing registered mails, and more particularly, to a registered mail managing system for automatically sorting out and distributing registered mails, and a method thereof.

2. Description of the Related Art

Development of computer technology has changed the modern society strikingly and automation is in progress in many fields. One of the fields neglected from the development, however, is a mail management and sorting in a post office, which is still following a conventional method of collecting mails manually on a district basis.

In particular, registered mails, which are produced more than 250 million cases per year, are received, sorted out, distributed and delivered all manually due to the importance and sensitive characteristics. The manual management is inefficient and it takes enormous costs to take care of the registered mails. This calls for the improvement in the management of registered mails.

Moreover, considering the current level of Korean information technology development, it can be said that it is far behind the times to manage the registered mails manually instead of automating the registered mail management.

### SUMMARY OF THE INVENTION

Accordingly, the present invention is directed to a registered mail management system and method that substantially obviates one or more problems due to limitations and disadvantages of the related art.

An object of the present invention is to provide a system for automatically sorting and distributing registered mails, and a method thereof.

Another object of the present invention is to provide a system for automatically sorting and distributing registered mails by using a bar code assigned to each registered mail in the stage of postal reception, and a method thereof.

A further another object of the present invention is to provide a system for automatically sorting and distributing registered mails by using a destination zip code of each registered mail, and a method thereof.

A still further another object of the present invention is to provide a system for automatically sorting and distributing registered mails by assigning a bar code including a destination zip code to each registered mail in the stage of postal reception and using the bar code, and a method thereof.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

According to an aspect of the present invention, there is provided a system for managing registered mails, which includes: a mail transfer block for transferring the registered mails inputted into the registered mail management system at a predetermined interval; an automatic mail sort and distribution block for detecting destination information of each registered mail transferred in the mail transfer block, and generating mail sorting control signal based on the destination information; a sorting block for sorting out the registered mails transferred through the mail transfer block according to each destination based on the mail sorting control signal; and a postal mailbox for separately storing the registered mails sorted out in the sorting block according to each destination.

According to an another aspect of the present invention, there is provided a method for managing registered mails, which includes the steps of: a) detecting a bar code image from a registered mail, when the registered mail is received; b) determining whether the bar code image includes a destination zip code; c) detecting a zip code from the bar code when the bar code image includes the destination zip code; d) detecting a registration number from the bar code image, when the bar code image does not include the destination zip code, and detecting a zip code corresponding to the registration number from the integrated mail information system; and e) automatically sorting out the registered mail based on the zip code.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram describing a registered mail management process;

FIG. 2 is a block diagram illustrating a registered mail management system in accordance with an embodiment of the present invention;

FIG. 3 is a block diagram showing an automatic mail sort and distribution block in accordance with an embodiment of the present invention;

FIG. 4 is a block diagram describing a bar code reader in accordance with an embodiment of the present invention;

FIG. 5 is an exemplary diagram illustrating a postal mailbox in accordance with an embodiment of the present invention;

FIG. 6 is a flowchart describing a registered mail management method in accordance with an embodiment of the present invention;

FIG. 7 is a flowchart describing a registered mail receiving method in accordance with an embodiment of the present invention; and

FIGS. 8A and 8B show a bar code for managing registered mails and a bar code application example, respectively, in accordance with an embodiment of the present invention.

### DETAILED DESCRIPTION OF THE INVENTION

Reference will now be made in detail to the preferred embodiments of the present invention, examples of which are illustrated in the accompanying drawings.

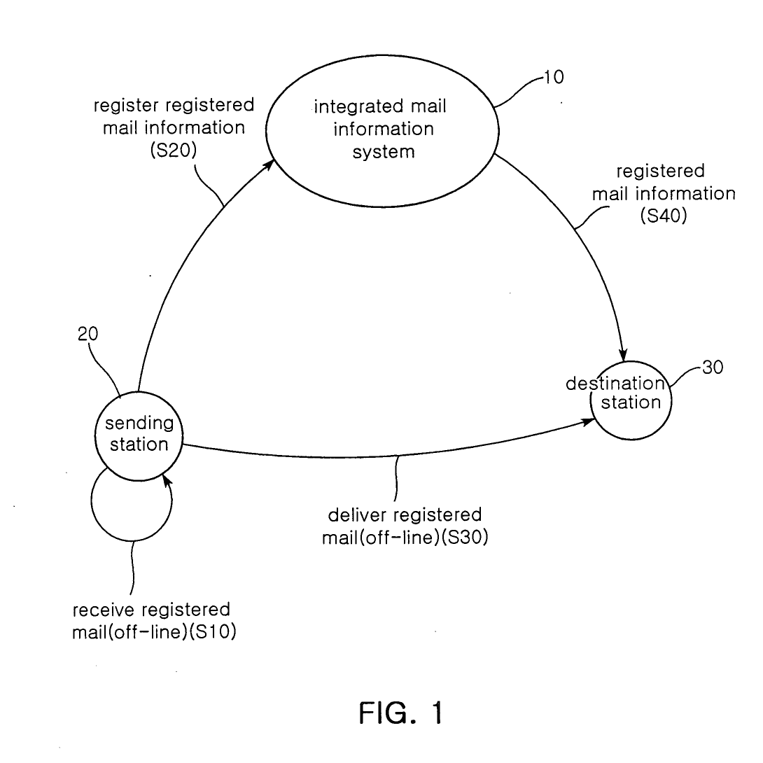

FIG. 1 is a diagram describing a registered mail management process. Particularly, the drawing presents an example where a registered mail received in a sending station 20 is delivered to a destination station 30. Referring to FIG. 1, a registered mail goes through the following processes. When a registered mail is received in the sending station 20 in step S10, a registered mail receptionist registers information on the registered mail, i.e., registered mail information, in an integrated mail information system 10 in step S20.

The registered mail is delivered to the destination station 30 through an off-line process in step S30. In the mean time, the integrated mail information system 10 transmits the registered mail information to the destination station 30 in step S40.

As illustrated in FIG. 1, the registered mail is received and delivered through the off-line process in the steps S10 and S30, and the registered mail information is transmitted to the destination station 30 through an on-line process using the integrated mail information system 10.

The present invention is directed to the reception and delivery of registered mails, which are carried out off-line, in the example of FIG. 1. In other words, the present invention suggests an apparatus for automating the reception and delivery of registered mails, which have been carried out manually in off-line, and a method thereof.

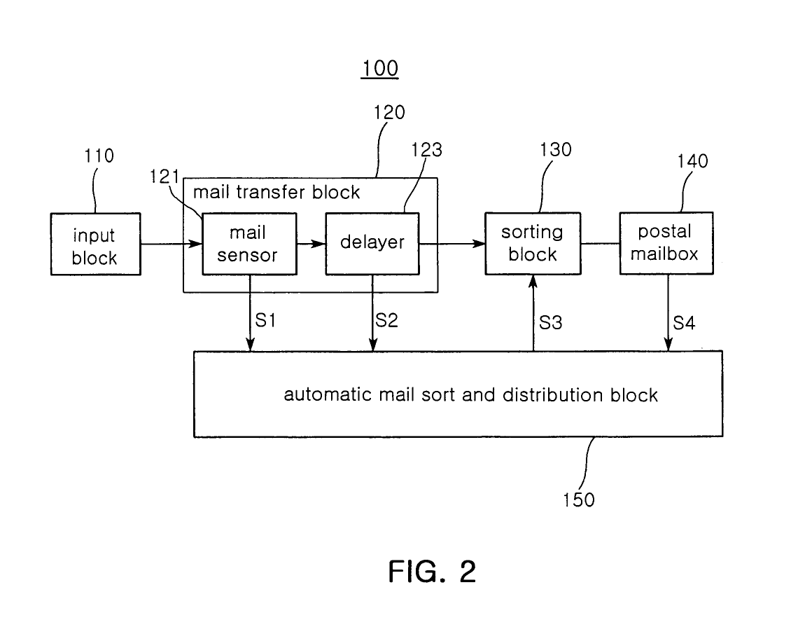

FIG. 2 is a block diagram illustrating a registered mail management system in accordance with an embodiment of the present invention. Referring to FIG. 2, the registered mail management system 100 suggested in the embodiment of the present invention includes an input block 110, a mail transfer block 120, a sorting block 130, a postal mailbox 140, and an automatic mail sort and distribution block 150.

Through the input block 110, registered mails are inputted into the registered mail management system 100 of the present invention.

The mail transfer block 120 transfers the registered mails inputted through the input block 110 at a predetermined interval. For this, it is preferred that the mail transfer block 120 is formed of a device capable of transferring target objects automatically, such as a conveyer belt. Also preferably, the mail transfer block 120 includes a mail sensor 121 and a delayer 123. The mail sensor 121 senses the size and shape of a registered mail inputted through the input block 110, and the delayer 123 delays the transfer speed of the registered mail so that the automatic mail sort and distribution block 150 can recognize the registration number and destination information, e.g., zip code, of the registered mail.

The mail sensor 121 detects the external information such as the size, thickness and slant of the inputted registered mail and transmits the external information to the automatic mail sort and distribution block 150. The delayer 123 delays the automatic transfer of registered mails at a predetermined interval to smoothly process the registered mail and the registered mail information.

The sorting block 130 sorts out the registered mails delivered through the mail transfer block 120 according to destination upon receipt of a control signal (S3) transmitted from the automatic mail sort and distribution block 150.

The postal mailbox 140 stores the registered mails sorted out in the sorting block 130 separately. To separately store the sorted registered mails, it is preferred that the postal mailbox 140 includes a plurality of partitions for storing registered mails for each destination and a partition sensing unit for monitoring the partitions to figure out whether there is a partition full of registered mail. When a partition is full of registered mails, the partition sensing unit transmits the partition state information (S4) to the automatic mail sort and distribution block 150.

The automatic mail sort and distribution block 150 checks out the registered mails during the transferring in the mail transfer block 120 to figure out information and automatically sorts out the registered mails based on the information. Also, it controls the distribution of the registered mails.

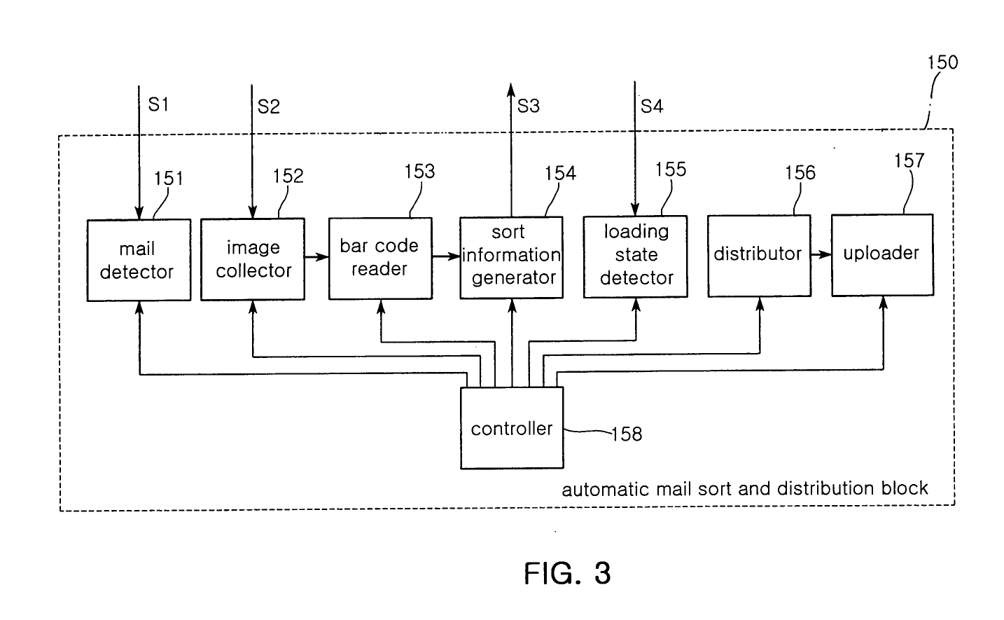

FIG. 3 presents a block diagram showing the structure of the automatic mail sort and distribution block 150. Referring to FIG. 3, the automatic mail sort and distribution block 150 includes a mail detector 151, an image collector 152, a bar code reader 153, a sort information generator 154, a loading state detector 155, a distributor 156, an uploader 157, and a controller 158.

The mail detector 151 receives the external information of a registered mail, such as the size, thickness and slant of the registered mail, from the mail sensor 121. Then, it determines whether the registered mail is packed in a standardized envelope based on the external information. If the registered mail is packed in a non-standardized envelope, the registered mail is rejected.

The image collector 152 collects image information of the registered mail while the registered mail passes through the delayer 122 and transmits the image information to the bar code reader 153. For this, it is preferred that the image collector 152 includes a vision camera. Also, it is preferred that the image collector 152 estimates where a bar code of the registered mail is to be placed in advance and collects only image information of the area where the bar code is supposed to be placed, instead of collecting all the image information of the registered mail.

The bar code reader 153 receives the image information of the registered mail from the image collector 152 and detects and reads out only the bar code from the image information. Herein, it is preferred that the bar code is read based on a conventional algorithm and the bar code includes information corresponding to a destination zip code of the registered mail.

The sort information generator 154 receives a bar code reading result from the bar code reader 153 and generates sort information for the corresponding registered mail based on the bar code reading result. To be specific, when the bar code reading result reveals a destination zip code, sort information generator 154 determines which one of the partitions the registered mail should be put in based on the zip code and it generates and transmits sort information to the sorting block 130. Then, the sorting block 130 performs control to put the registered mail into a corresponding partition of the postal mailbox 140 based on the sort information.

The loading state detector 155 receives partition state information such as whether there is a partition full of registered mails from the postal mailbox 140 and controls the distributor 156 to distribute the registered mails into the partitions properly.

The distributor 156 automatically distributes registered mails for the partition already full of mails based on the partition state information sensed in the loading state detector 155.

The uploader 157 uploads the distribution result of the distributor 156 into the integrated mail information system 10.

The controller 158 controls the operation of the constitutional elements of the automatic mail sort and distribution block 150, i.e., the mail detector 151, the image collector 152, the bar code reader 153, the sort information generator 154, the loading state sensor 155, the distributor 156, and the up-loader 157.

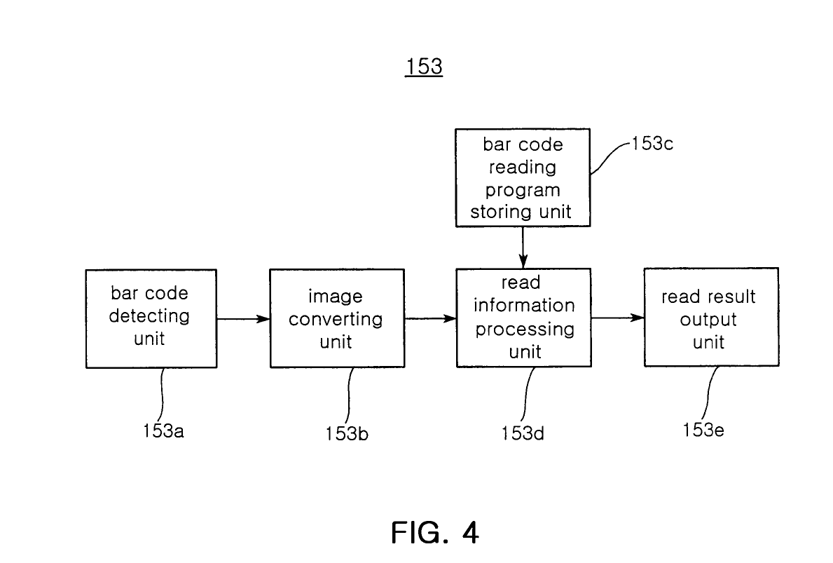

FIG. 4 is a block diagram illustrating the bar code reader in accordance with an embodiment of the present invention. Referring to FIG. 4, the bar code reader 153 of FIG. 3 includes a bar code detecting unit 153a, an image converting unit 153b, a bar code reading program storing unit 153c, a read information processing unit 153d, and a read result output unit 153e.

The bar code detecting unit 153a detects out only a bar code image from the image information transmitted from the image collector 152. The image converting unit 153b converts the detected bar code image into a format that can be read by a pre-stored bar code reading program, for example, a 640×480 8-bit BMP format.

The bar code reading program storing unit 153c stores a program for reading a bar code.

The read information processing unit 153d reads the bar code image information transmitted from the image converting unit 153b based on the bar code reading program stored in the bar code reading program storing unit 153c.

The read result output unit 153e outputs the bar code reading result of the read information processing unit 153d. Herein, it is preferred that the outputted bar code reading result is the zip code of a destination where the corresponding registered mail is to be delivered.

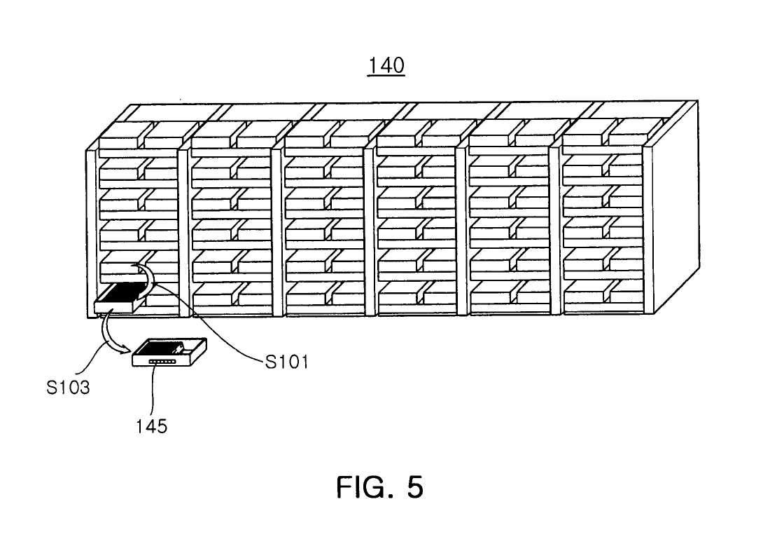

FIG. 5 is an exemplary diagram showing a postal mailbox in accordance with an embodiment of the present invention. Referring to FIG. 5, the postal mailbox 140 suggested in the present embodiment includes a plurality of partitions for separately storing the registered mails according to each destination which is identified by a zip code. When a registered mail is delivered to the postal mailbox 140 through the mail transfer block 120 and a partition where the registered mail should be loaded is determined in step S101 based on the bar code reading result obtained by reading a bar code attached to the registered mail, the registered mail is put into the determined partition 145 in step S103.

When a partition is full of registered mails, information on the partition state, i.e., partition state information, is transmitted to the automatic mail sort and distribution block 150 in order to automatically process and distribute registered mails into the correct partitions based on the mail state information.

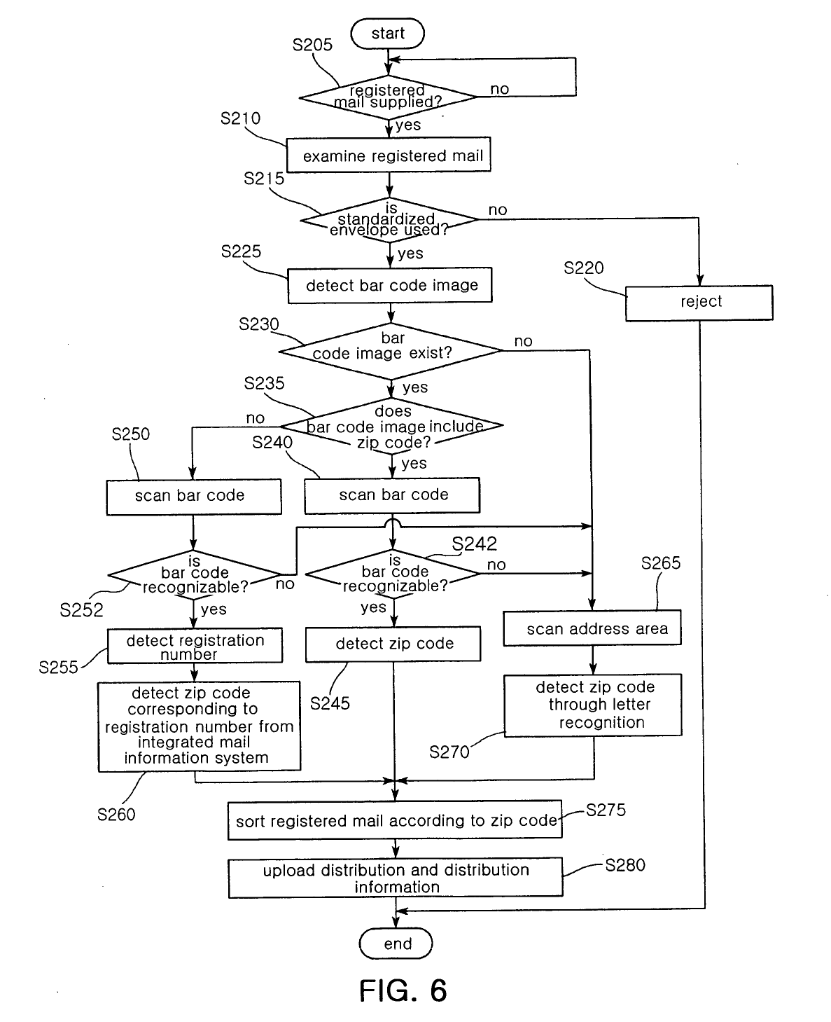

FIG. 6 is a flowchart describing a registered mail management method in accordance with an embodiment of the present invention.

Referring to FIG. 6, registered mails are managed as follows. First, in step S205, a registered mail is received and supplied to the registered mail management system of the present invention. In step S210, the registered mail management system examines the state of the supplied registered mail to figure out the external information of the registered mail, such as the size, thickness and slant of the registered mail, and determines whether a standardized envelope is used for the registered mail.

In step S215, when a standardized envelope is not used for the registered mail, the registered mail management system rejects the registered mail in step S220. In short, the registered mail management system cannot handle a registered mail of a non-standardized envelope. The registered mail management system goes into a waiting mode until another registered mail is supplied.

On the other hand, when it is figured out in the step S210 that a standardized envelope is used for the registered mail, the registered mail management system automatically detects a bar code image from the registered mail in step S225. To detects the bar code image, it is preferred that the registered mail management system collects image information of the registered mail and detects the bar code image from the registered mail image information sequentially. Also, it is preferred to attach a bar code label to a predetermined area of the registered mail to automatically detect the bar code image from the registered mail image information. Since the registered mail management system collects image information only from the predetermined area of the registered mail, it is possible to reduce the load applied to the registered mail management system for the collection and process of the image information.

When there is a bar code image to be automatically detected in the step S230, the registered mail management system determines whether the bar code image includes a zip code in step S235. To be specific, it determines whether the bar code is generated based on a Code 128 Standard including a zip code or based on a Code 39 Standard not including a zip code.

When the bar code image detected in the step S225 includes a zip code of a destination, that is, when the bar code is generated based on the Code 128 Standard, the registered mail management system scans the bar code image in step S240. When the scanned bar code image is recognizable in step S242, the zip code is detected from the bar code image in step S245. Then, the registered mail is sorted out automatically based on the zip code in step S275. When the registered mail is distributed, the distribution information is uploaded in the integrated mail information system in step S280.

On the other hand, when the bar code image detected in the step S225 does not include any zip code, that is, when the bar code is generated based on the Code 39 Standard, the registered mail management system scans the bar code image in step S250. When the scanned bar code image is recognizable in step S252, a registration number of the registered mail is detected from the bar code image in step S255. Subsequently, a zip code corresponding to the registration number is obtained from the integrated mail information system in step S260. This is possible because a registration number is assigned to the registered mail when the registered mail is received and, at the same time, the registration number is stored in the integrated mail information system.

Meanwhile, if there is no bar code image in the registered mail in the step S230 or if the scanned bar code image is not recognizable in the step S242 or S252, the registered mail management system of the present invention scans the address area of the registered mail in step S265 and detects a zip code included in the address area based on letter recognition in step S270. When the zip code is detected from the steps S260 and S270, the registered mail management system of the present invention sorts out the registered mail automatically in the step S275 and distributes it based on the destination zip code and uploads result information of the sort and distribution to the integrated mail information system in the step S280.

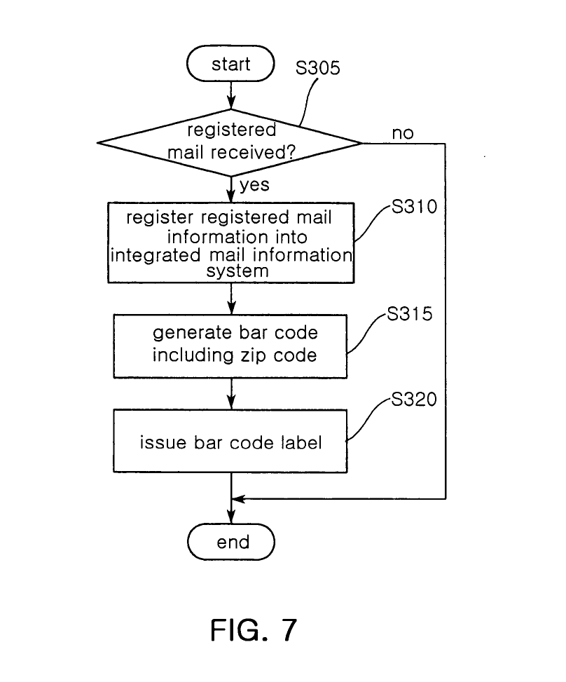

Herein, in order to detect the destination zip code of the registered mail from the bar code image, it is preferred to generate a bar code including a zip code at the stage of registered mail reception, issue a bar code label and attach the bar code label to a predetermined position of the registered mail. The mail receiving process described above is illustrated in FIG. 7.

FIG. 7 is a flowchart describing a registered mail receiving method in accordance with an embodiment of the present invention. Referring to FIG. 7, a registered mail is received as follows.

First, when the registered mail is received in step S305, a receptionist in charge of registered mail registers information on the registered mail, registered mail information which includes a sending station, a destination station, the name of a sender and the date of sending, in the integrated mail information system in step S310. Since the registration method is not the point of the present invention, further description on the registration method will not be provided in the present specification.

When the registered mail information is registered in the integrated mail information system in the step S310, the registered mail management system of the present invention generates a bar code including the destination zip code of the registered mail in step S315. Then, it issues a bar code label in step S320.

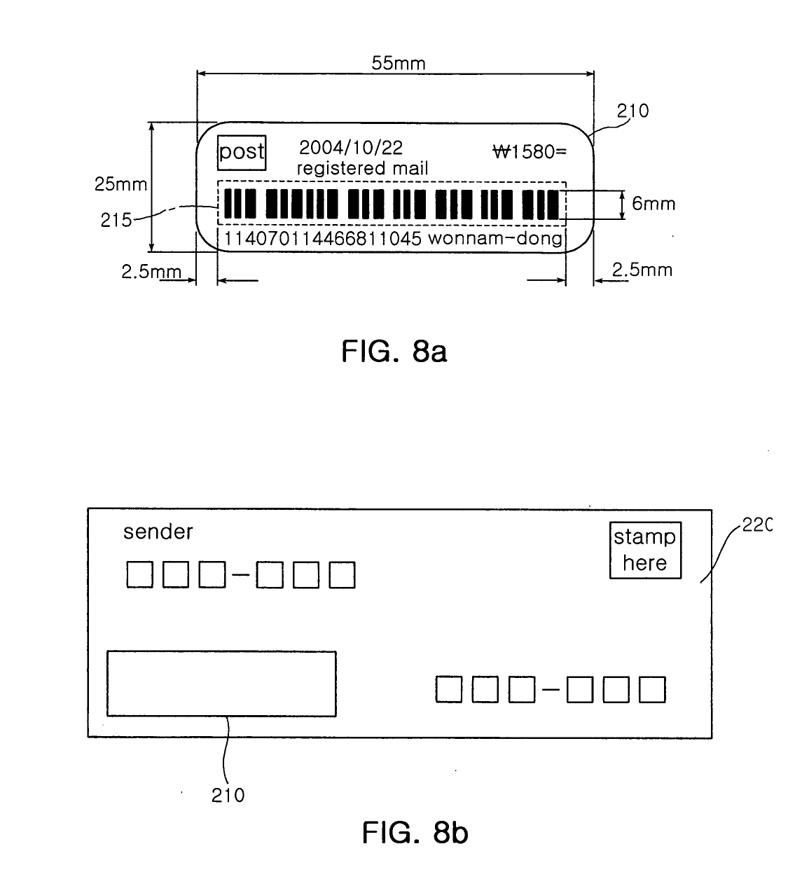

An example of the issued bar code label is shown in FIG. 8A. Referring to FIG. 8A, the issued bar code label 210 includes a bar code 215 generated in the step S315. Preferably, the bar code is generated based on the C128 Standard. In particular, the bar code is of a code set C type in the Code 128 Standard and, preferably, the bar code is defined to use not ASCII Code characters but check bits optionally.

The bar code of the Code 128 Standard is formed of 19 places and bar codes have different characteristics according to the positions of a zip code and a registration number and different structures according to how the registered mail is received. For example, when the zip code comes before the registration number, the sorting efficiency is fine and a serial number search is not affected. Also, there is no big problem in maintaining consistency with the conventional bar code system and data scheme. However, when the zip code is placed behind the registration number, it is relatively less efficient to perform sorting and the serial number search is affected by the changed position. Also, it is easier to maintain consistency with the conventional bar code system and data scheme.

Examples of bar code scheme based on the reception type will be described hereafter.

When a bar code is generated for a registered mail received in a post office and a zip code comes before a registration number, the bar code is formed to have ‘6 places for zip code+1 place for kind+4 places for reception station of the registration mail+8 places for serial number.’ When the zip code comes behind the registration number, the bar code is preferably formed to have ‘1 place for kind+4 places for reception station of the registration mail+8 places for serial number+6 places for zip code.’

Also, when the bar code is generated for a bunch of registered mails and the zip code comes before the registration number, the bar code is formed to have ‘6 places for zip code+1 place for kind+1 place for identification+5 places for customer number+8 places for serial number.’ When the zip code comes behind the registration number, the bar code is formed to have ‘1 place for kind+1 place for identification+5 places for customer number+8 places for serial number+6 places for zip code.’

Meanwhile, when a bar code is generated for a pre-received registered mail and a zip code comes before a registration number, the bar code is formed to have ‘6 places for zip code+1 place for kind+1 place for identification+11 places for serial number.’ When the zip code comes behind the registration number, it is preferred that the bar code is formed to have ‘1 place for kind+1 place for identification+11 places for serial number+6 places for zip code.’

Preferably, the bar code label including the bar code 215 formed as described above maintains a right and left bar code print margin of at least 2.5 mm and a height of at lest 6 mm. Also, it is preferred that the printing density of the bar code is 2 dots or 3 dots. Herein, the ‘dot’ is an expression related to a head of a bar code printer. Generally, a bar code printer has a head of 8 dots or 12 dots. This means that 8 or 12 black dots are printed in a unit area of 1 mm². The larger the dot number is, the finer the bar code can be printed. Therefore, a remark that a two-dot bar code means that a thin bar of the bar code is printed in two dots in the unit area, whereas three-dot bar code means that a thin bar of the bar code is printed in three dots in the unit area. The smaller the dot number is, the higher the print density of the bar code label is.

Meanwhile, it is preferred that the bar code is printed in any one method among a laser printing method, a thermal printing method, and an inkjet printing method. In particular, the laser printing method is suitable for reception of a bunch of registered mails and the thermal printing method is suitable for reception of individual registered mail, while the inkjet printing method is suitable for the reception of both individual registered mail and a bunch of registered mails.

Also, it is preferred that the bar code is printed in black.

When the bar code is printed based on the Code 128 Standard, it is preferred that the definition is 300 dpi and, when it is printed based on the Code 39 Standard, the preferred definition is 250 dpi.

The bar code label issued in the above-described form is attached to the registered mail. Preferably, the bar code label is attached to a predetermined position of the registered mail. FIG. 8B shows an example of the bar code label attached to a predetermined position. Referring to FIG. 8B, the bar code label 210 is preferably attached to the left lower part of the registered mail envelope 220.

As described above, the technology of the present invention automatically sorts out and distributes registered mails based on destination zip codes. Automating the manual work for managing registered mails which amount to 250 million cases per year, it can reduce the enormous costs and improve the inefficiency of the registered mail management.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A system for managing registered mails, comprising:
a mail transfer block for transferring the registered mails inputted into the registered mail management system at a predetermined interval;
an automatic mail sort and distribution block for detecting destination information of each registered mail transferred in the mail transfer block, and generating mail sorting control signal based on the destination information;
a sorting block for sorting out the registered mails transferred through the mail transfer block according to each destination based on the mail sorting control signal; and
a postal mailbox for separately storing the registered mails sorted out in the sorting block according to each destination.

2. The system of claim 1, wherein the mail transfer block includes:
a mail sensor for detecting external information of each registered mail and transmitting the external information to the automatic mail sort and distribution block; and
a delayer for delaying the automatic transfer of the registered mails at a predetermined time interval to smoothly process the registered mails and information on each registered mail, i.e., registered mail information.

3. The system of claim 2, wherein the automatic mail sort and distribution block includes:
a mail detector for receiving external information of each registered mail from the mail sensor and rejecting a registered mail of a non-standardized envelope;
an image collector for collecting image information of each registered mail while the registered mail passes through the delayer;
a bar code reader for receiving the image information of each registered mail from the image collector, detecting only a bar code image from the image information, and reading the bar code to thereby produce a bar code reading result; and
a sort information generator for generating a mail sorting control signal, which is a sort information of the registered mail, based on the bar code reading result.

4. The system of claim 3, wherein an area where the bar code is to be attached is predetermined and the image collector collects only image information of the predetermined bar code area.

5. The system of claim 3, wherein the bar code reader includes:
a bar code reading program storing unit for storing a bar code reading program to read the bar code from the bar code image;
a bar code detecting unit for detecting only the bar code image from the image information transmitted from the image collector;
an image converting unit for converting the detected bar code image into a format that can be read by the bar code reading program;
a read information processing unit for reading the converted bar code image based on the bar code reading program to thereby produce a read result; and
a read result output unit for outputting the read result.

6. The system of claim 1, wherein the postal mailbox includes:
a plurality of partitions for separately storing the registered mails according to destination; and
a sensor for monitoring the partitions to figure out whether a partition is full, i.e., the partition state information,
wherein the partition state information is transmitted to the automatic mail sort and distribution block when at least one of the partitions is full of registered mails.

7. The system of claim 6, wherein the automatic mail sort and distribution block further includes:
a distributor for performing automatic distribution on the registered mails based on the partition state information; and
an uploader for transmitting the distribution result of the distributor into an integrated mail information system.

8. A method for managing registered mails, comprising the steps of:
a) detecting a bar code image from a registered mail, when the registered mail is received;
b) determining whether the bar code image includes a destination zip code;
c) detecting a zip code from the bar code when the bar code image includes the destination zip code;
d) detecting a registration number from the bar code image, when the bar code image does not include the destination zip code, and detecting a zip code corresponding to the registration number from the integrated mail information system; and
e) automatically sorting out the registered mail based on the zip code.

9. The method of claim 8, further comprising the step of:
f) automatically uploading the distribution information into the integrated mail information system, when the registered mails are sorted and distributed.

10. The method of claim 8, further comprising the step of:
g) when there is no bar code image in the registered mail or when the bar code is not recognizable in the automatic bar code image detection step, scanning an address area of the registered mail based on the predetermined address area information of the registered mail and detecting a zip code through letter recognition.

11. A method for receiving a registered mail, comprising the steps of:
a) when a registered mail is received, generating a bar code including a destination zip code of the registered mail;
b) issuing a bar code label by using the generated bar code; and
c) attaching the bar code label to the registered mail.

12. The method of claim 11, wherein the generated bar code is a code set C type based on a Code 128 Standard and the bar code is defined to use not ASCII code characters but use check bits optionally in the bar code generation step a).
